(19) United States
(12) Patent Application Publication
(10) Pub. No.: US 2011/0227356 A1
(43) Pub. Date: Sep. 22, 2011

(54) Brush remover

(75) Inventor: James D. Oberg, Eagle Bend, MN (US)

(73) Assignee: BAC INDUSTRIES, INC., Eagle Bend, MN (US)

(21) Appl. No.: 13/151,792

(22) Filed: Jun. 2, 2011

Related U.S. Application Data
(62) Division of application No. 12/023,203, filed on Jan. 31, 2008, now abandoned.

(51) Int. Cl. A01G 23/06; B66C 1/30

(52) U.S. Cl. 294/119

(57) ABSTRACT

In some embodiments, a brush remover may include one or more of the following features: (a) an elongated frame, (b) an operator's station located at an end of the elongated frame, (c) scissor gear located at an opposite end of the elongated frame, (d) an actuation lever coupled to the frame, (e) a cable operably coupled to the actuation lever and to the scissor gear, (f) a support leg coupled to the opposite end of the elongated frame adjacent to the scissor gear, (g) a pincher operably coupled to the scissor gear, (h) a tine located on a pinching surface of the pincher, and (i) a spring operably coupled to the scissor gear.

### CROSS REFERENCE TO RELATED APPLICATION

This application is a division of application Ser. No. 12/023,203, filed Jan. 31, 2008.

### I. FIELD OF THE INVENTION

Embodiments of the present invention generally relate to landscape maintenance tools.

Particularly, embodiments of the present invention relate to tools for the removal of plant life from the ground. More particularly, embodiments of the present invention relate to devices for use in uprooting woody plants and trees from the soil.

### II. BACKGROUND

Homeowners, foresters, agriculturists, landscape workers and the like often need to permanently remove unwanted shrubs and small trees. Rangers and volunteers who care for public park woodlands face an ongoing need to remove invading exotic shrubs and trees disrupting the balanced ecosystem of native plant varieties. Problems associated with clearing young trees and woody shrubs from an area have involved back-breaking toil, using picks and shovels to uncover the roots, then pulling by hand or with the help of draft animals, or in more modern times, with tractors and winches. While this approach was effective, it was laborious, it required considerable physical strength, and it disturbed a much larger area than the plant occupied.

Another approach was to cut the plant at the soil line using one of a variety of hand or fuel-powered blade tools, leaving the plant's root system intact beneath the surface. This left an area looking cleared with a minimum of disturbance to the surroundings, but soon new growth would appear from the old roots, and the plant would come back bushier and more difficult to remove than before. Furthermore, blade tools required strength and skill to use; fuel-powered tools provided noise and fumes, as well as high purchase and maintenance costs.

A third approach was to use herbicides to kill the unwanted brush or small trees. A trained operator used expensive and potentially hazardous chemicals in a spraying apparatus to poison the target plant. The nearby desirable plants were often harmed by overspray of the herbicide. When the target plant was dead, there still remained the problem of extracting it. Many questions remain about the long-term effects of herbicides on humans, wild animals and the environment. Therefore, public park agencies and property owners have become reluctant to use chemical herbicides. Parks in particular use chemicals only as a last resort rather than provoke public outrage.

Most users, therefore, would find it desirable to have a tool which could grip an unwanted shrub or tree and uproot it completely, easily, and safely, without undue disturbance to neighboring vegetation, or harm to the user or to the environment. It would also be desirable to provide a tool for easily grasping and uprooting woody plants; to provide such a tool which can be effectively and safely operated by a person of ordinary physical strength and with little training or experience; to provide such a tool which acts selectively on the target plant with minimum disturbance to surrounding vegetation; to provide such a tool which extracts sufficient root to kill the plant, leaving no stump to re-sprout later; and to provide such a tool which requires no fuel or chemicals for its effective operation. It would be further desirable to provide a tool which is easily hand-carried to the site of operation; to provide such a tool which requires little storage space and minimal maintenance.

### III. SUMMARY OF THE INVENTION

In some embodiments, a brush remover may include one or more of the following features: (a) an elongated frame, (b) an operator's station located at an end of the elongated frame, (c) scissor gear located at an opposite end of the elongated frame, (d) an actuation lever coupled to the frame, (e) a cable operably coupled to the actuation lever and to the scissor gear, (f) a support leg coupled to the opposite end of the elongated frame adjacent to the scissor gear, (g) a pincher operably coupled to the scissor gear, (h) a tine located on a pinching surface of the pincher, and (i) a spring operably coupled to the scissor gear.

In some embodiments, a plant removal apparatus may include one or more of the following features: (a) an elongated frame, (b) an operator's station located at one end of the elongated frame, (c) an activation lever coupled to a midsection of the elongated frame, (d) a support leg located at an opposite end of the elongated frame, (e) a scissor gear located adjacent to the support leg coupled to the elongated frame, (f) a cable operably coupled to the activation lever and the scissor gear, (g) a handle coupled to the activation lever, and (h) a pincher coupled to the scissor gear, the pincher having at least one tine to engage fibrous material of a plant.

In some embodiments, a plant removal method may include one or more of the following steps: (a) positioning pinchers of a plant removal apparatus around a base of the plant, (b) engaging the pinchers to clamp the base of the plant between the pinchers, (c) pushing downward on an operator's section of the removal apparatus to force the plant from a ground base, (d) removing the plant from between the pinchers, and (e) ensuring the pinchers are open before placing the pinchers around the base of the plant.

In some embodiments, a brush remover, may include one or more of the following features: (a) a first and second arm coupled together at a first end by a fastener, (b) an eyelet coupled to the first and second arm by the fastener, (c) pinchers coupled to the first and second arm at a second end, (d) tines attached to the pinchers, and (e) a spring coupled between a second fastener located on the first arm and a third fastener located on the second arm.

In some embodiments, a plant removal apparatus, may include one or more of the following features: (a) a force source connector, (b) a body coupled to the force source connector at a first end, (c) scissor gear coupled to the body at a second end, (d) guide rails located adjacent to the scissor gear, (e) a cable operably coupled to the scissor gear, (f) a screw handle operably coupled to the force source connector for securing the plant removal apparatus to a force source, (g) a detent operably coupled to the scissor gear, (h) at least one spring coupled to the scissor gear and to a detent, and (i) a pincher coupled to the scissor gear, the pincher having at least one tine to engage fibrous material of a plant.

### IV. DESCRIPTION OF THE DRAWINGS

FIG. 1 shows an isometric view of a brush remover in an embodiment of the present invention;

FIG. 2 shows a side view of an actuation lever in an embodiment of the present invention;

FIG. 3 shows an upper elevation view of a scissors gear in an open position in an embodiment of the present invention;

FIG. 4 shows an upper elevation view of a scissors gear in a closed position in an embodiment of the present invention;

FIG. 5 shows a process flow diagram for operation of a brush remover in an embodiment of the present invention;

FIG. 6 shows an upper elevation view of a brush remover in operation in an embodiment of the present invention;

FIG. 7 shows an upper elevation view of a brush remover in an embodiment of the present invention;

FIG. 8 shows a side elevation profile view of a brush remover in an embodiment of the present invention;

FIG. 9 shows a side elevation profile view of a brush remover in an embodiment of the present invention; and

FIG. 10 shows a front profile view of pinchers on a brush remover in an embodiment of the present invention.

### V. DESCRIPTION OF THE PREFERRED EMBODIMENT

The following discussion is presented to enable a person skilled in the art to make and use the present teachings. Various modifications to the illustrated embodiments will be readily apparent to those skilled in the art, and the generic principles herein may be applied to other embodiments and applications without departing from the present teachings. Thus, the present teachings are not intended to be limited to embodiments shown, but are to be accorded the widest scope consistent with the principles and features disclosed herein. The following detailed description is to be read with reference to the figures, in which like elements in different figures have like reference numerals. The figures, which are not necessarily to scale, depict selected embodiments and are not intended to limit the scope of the present teachings. Skilled artisans will recognize the examples provided herein have many useful alternatives and fall within the scope of the present teachings. While embodiments of the invention discussed below are discussed in detail with respect to removal of small trees and brush, it is fully contemplated embodiments of the present invention could be utilized for most any type of vegetation without departing from the spirit of the invention.

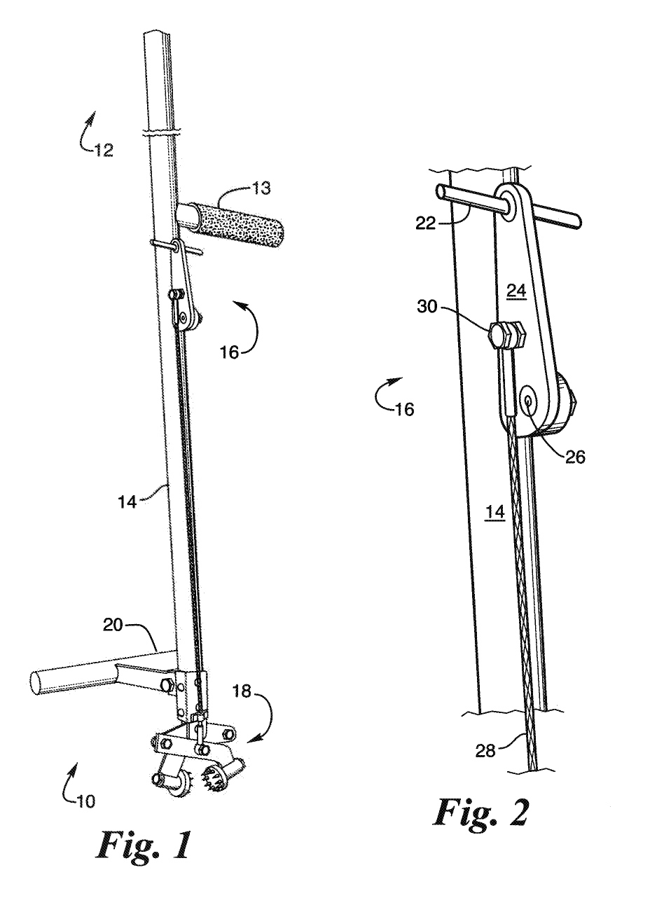

With reference to FIG. 1, an isometric view of brush remover 10 in an embodiment of the present invention is shown. Brush remover 10 can have an elongated frame 14 terminating in an operator's station 12 at one end and possibly having a handle 13. Located approximately midway on frame 14 is actuation lever 16. Actuation lever 16 can be connected to scissor gear 18 located at an opposite end of frame 14. A support leg 20 is also located at this end providing leverage as will be discussed in more detail regarding the operation of remover 10.

Operators' station 12 can take most any form, such as a gripped bicycle handle, a T-bar, or simply a padded grip on the end of frame 14 without departing from the spirit of the invention. Regardless of the orientation of operator's station 12, the purpose of operator's station 12 is to provide the operator with a firm handle on frame 14 to apply enough leveraged force at the opposite end of frame 14 to force a small tree or bush 80 out of the ground as will be discussed in more detail below.

With reference to FIG. 2, a side view of actuation lever 16 in an embodiment of the present invention is shown. Actuation lever 16 can have a grip 22, body 24, and a rotation point 26. Grip 22 is for ease of use for the operator in rotating lever 16 from a forward to a rearward position during operation of remover 10. The operator would simply grab onto grip 22 with his/her fingers. Body 24 is connected to rotation point 26 which is coupled to frame 14 with a fastening device allowing movement of body 24 back and forth from a forward to rearward position. Also attached to body 24 is a cable 28 coupled to body 24 with fastening device 30. The operation of cable 28 will be discussed in more detail below.

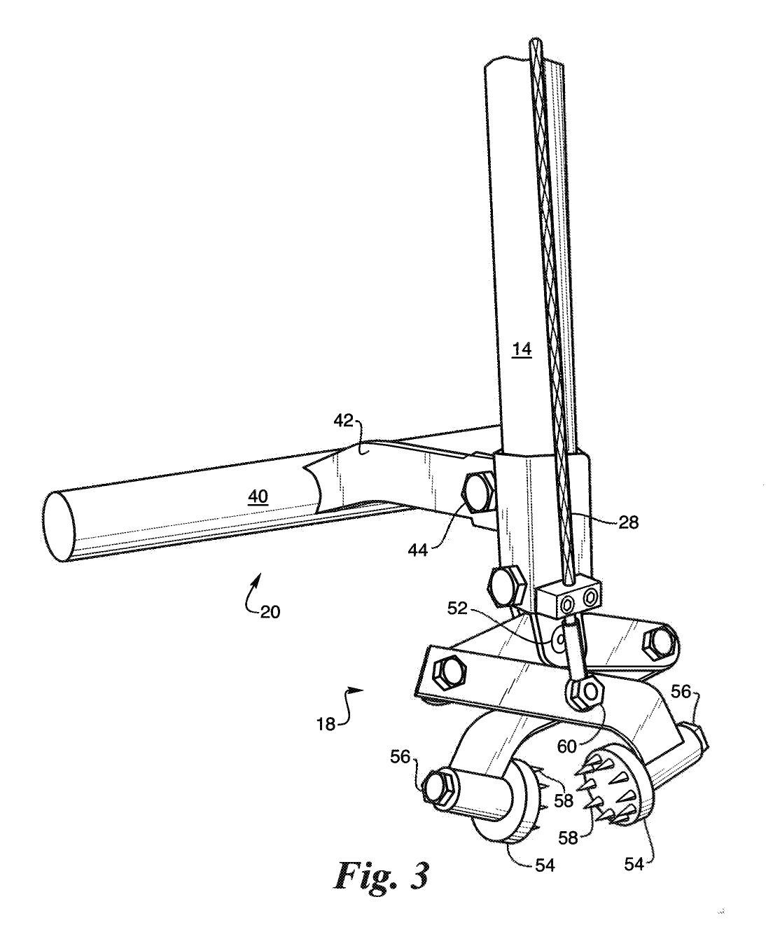

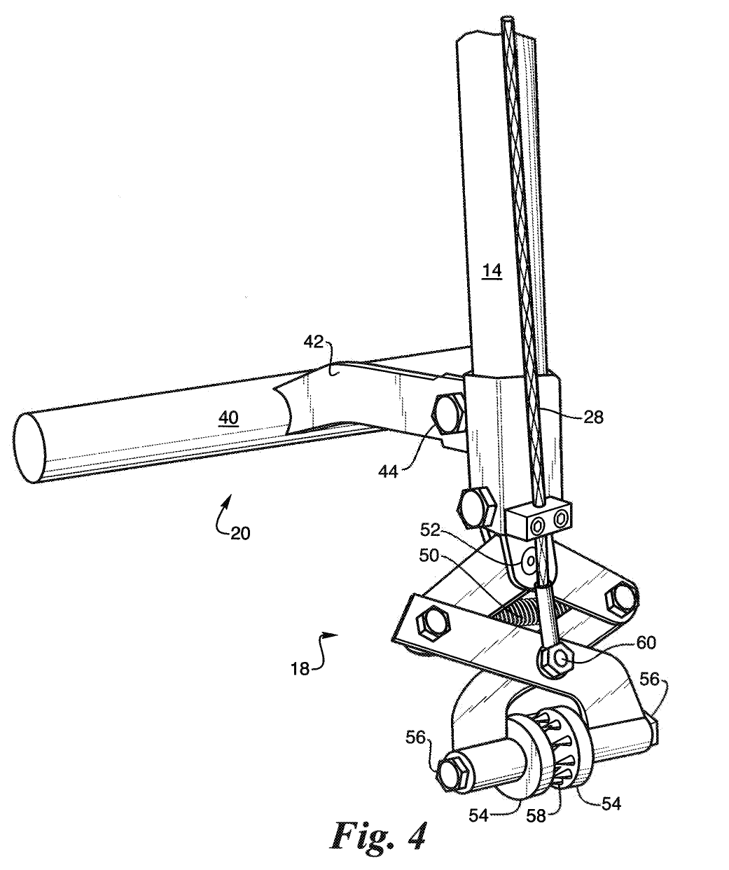

With reference to FIGS. 3 and 4, an upper elevation view of scissors gear 18 in an open and closed position respectively in an embodiment of the present invention is shown. Support leg 20 can have a leg base 40 and a curved stand portion 42 fastened to frame 14 with fastening device 44. The operation of support leg 20 is discussed in more detail below.

With actuation lever 16 in a rearward position (e.g., lever 16 is facing towards the operator), scissor gear 18 is in a tensioned state expanding spring 50 (FIG. 3). Thus, scissor gear 18 is kept in a tension state when actuation lever 16 is in a rearward position. Scissor gear 18 is coupled to frame 14 with a fastener 52 allowing rotation of scissor gear 18 at the end of frame 14. Thus brush remover 10 could be operated around corners or in hard to reach areas by manipulating scissor gear 18. Coupled to the end of scissor gear 18 with fasteners 56 are a pair of pinchers 54. Pinchers 54 have tines 58 to actively penetrate into a material, such as a woody fiber of a small tree or bush 80, when scissor gear 18 is placed into a closed position.

Actuation lever 16 is coupled to cable 28 which is coupled to fastener 60 on scissor gear 18. When actuation lever 16 is placed in the forward position (e.g., facing away from the operator), spring 50 contracts and closes pinchers 54 together lodging tines 58 into whatever material is located between tines 58.

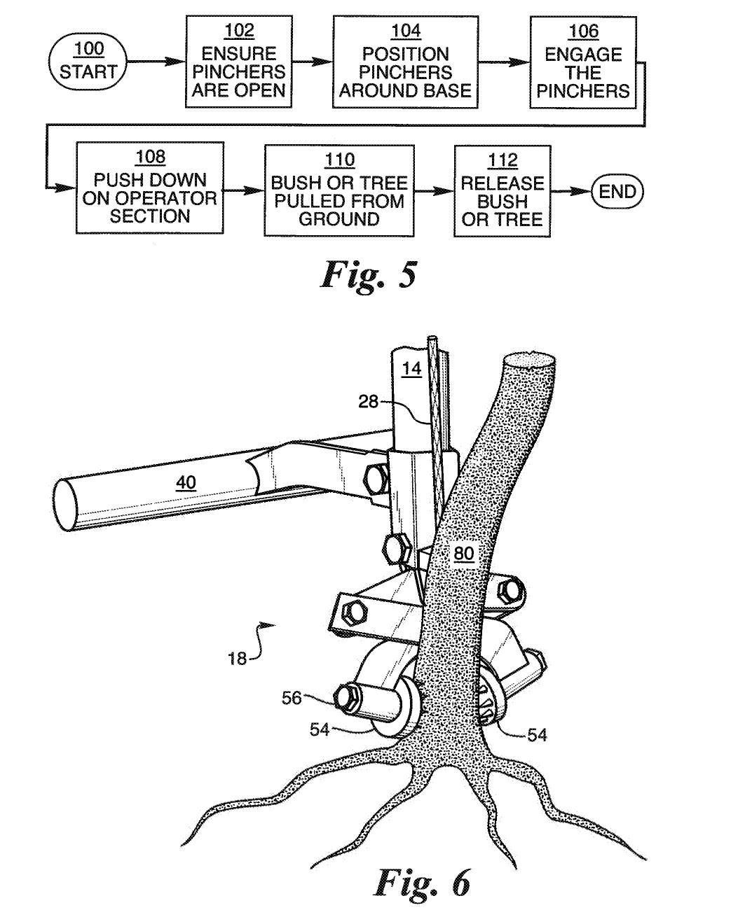

With respect to FIGS. 5 and 6, a process flow diagram for operation of brush remover 10 in an embodiment of the present invention is shown. In operation 100, an operator would ensure pinchers 54 are in an open position (FIG. 3) at state 102. The operator would then position pinchers 54 around the base of a bush or tree 80 at state 104. The operator would then move actuating lever 16 forward to close pinchers 54 and engage tines 58 into the base of bush or tree 80 at state 106. With pinchers 54 engaged, the operator would ensure support leg 20 is securely on the ground and begin to push downward on operator's section 12 at state 108. The leverage provided by the fulcrum of support leg 20 allows the operator to pull bush or tree 80 from the ground at state 110. The operator can now pull actuation lever 16 to its rearward position, thus, opening pinchers 54 and releasing bush or tree 80 at state 112. Bush or tree 80 can now be disposed of how the operator wishes.

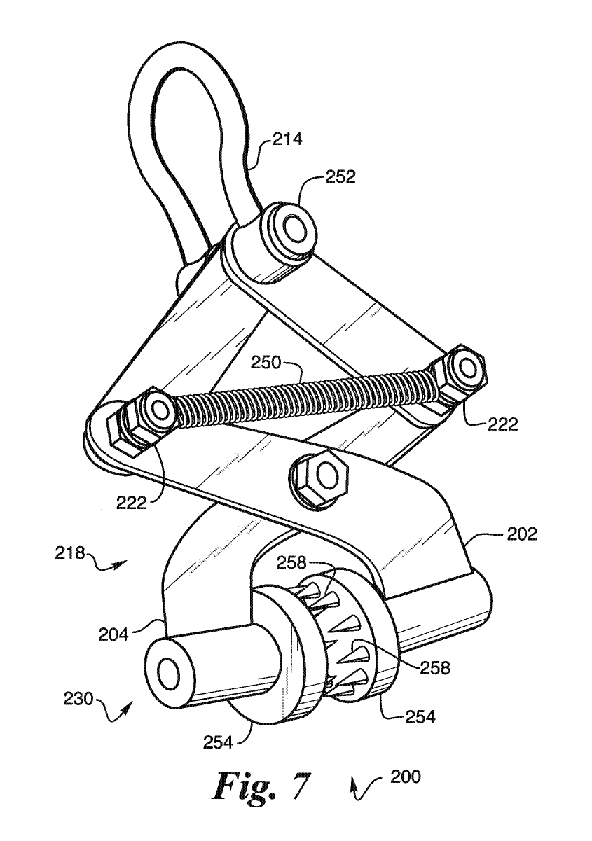

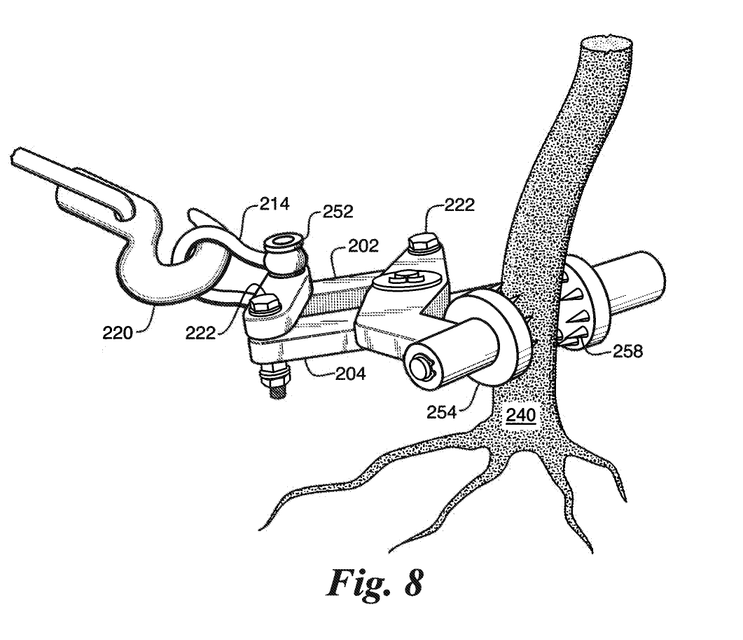

With reference to FIG. 7, an upper elevation view of brush remover 200 in an embodiment of the present invention is shown. Brush remover 200 can have scissor gear 218 having a right arm 202 and a left arm 204. Scissor gear 218 is coupled to an eyelet 214 with a fastener 252 allowing scissor gear 218 to be connected by a link 220 (FIG. 8) to a force source, such as an ATV, yard tractor, truck, etc. Link 220 could be most anything creating a stable force link between the force source and brush remover 200. Link 220 could be a chain, a rope, or wire without departing from the spirit of the invention. Located between joint fasteners 222 is a spring assembly 250 connecting joint fasteners 222. Located at one end 230 opposite eyelet 214 are a pair of pinchers 254. Pinchers 254 have tines 258 to actively penetrate into a material, such as a woody fiber of a small tree or bush 240.

With reference to FIG. 8, an elevational side profile view of brush remover 200 in an embodiment of the present invention is shown. In FIG. 7, brush remover 200 is in a relaxed or natural state. Thus, spring 250 is pulling joint fasteners 222 together thus forcing arms 202 and 204 together at end 230. When an operator desires to use brush remover 200 to remove an article of vegetation, tree, bush, or a post from the ground, the operator would simply pull open end 230 with his/her hands tensioning spring 250. After pinchers 254 are open wide enough to be placed on the surface of a tree 240, brush, or post, the operator would place pinchers 254 around a tree 240, hopefully around the base of tree 240. After the operator releases end 230, spring 250 recoils placing tension back on joint fasteners 222 thus closing pinchers 254 around tree 240. The operator can hook eyelet 214 to link 220, which would hopefully be connected to a force source. When ready, the operator would simply apply power to the force source, thus applying force to link 220, which in turn places pulling force on brush remover 200 and tree 240.

Brush remover 200 is also ensured not to be pulled off of tree 240 due to the force put upon eyelet 214. Thus, as the force source places pulling force on eyelet 214, this force is passed through fastener 252 and pulls fasteners 222 toward fastener 252. This acts to pull fasteners 222 closer together thus increasing the pressure on pinchers 254 together actually increasing the amount of pressure holding tree 240.

When the operator has removed tree 240, the operator would simply allow some slack to link 220, thus reducing the force on brush remover 200. The operator would simply pull pinchers 254 apart and release tree 240. The operator can then dispose of tree 240 in an environmentally friendly way.

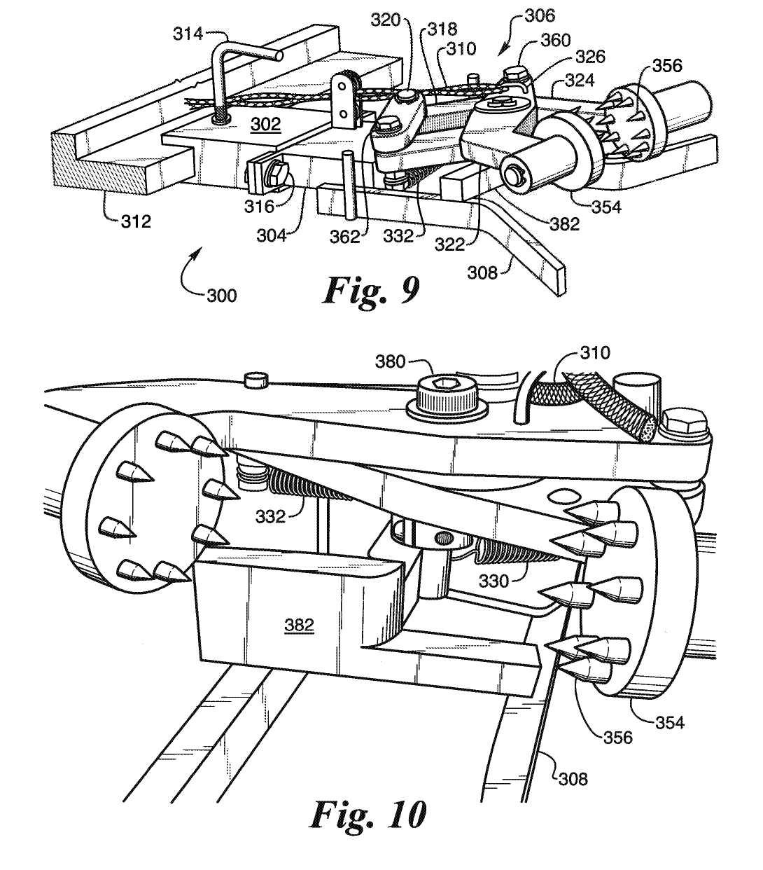

With reference to FIG. 9, a side elevation profile view of brush remover 300 in an embodiment of the present invention is shown. Brush remover 300 can have a force source connector 302, body 304, scissor gear 306, guide rails 308, and control cable 310. Similar to embodiments above, a force source 312 is used to provide enough force to remove a tree, brush, or post from the ground. Force source connector 302 is basically a “U” shaped joint which is to be placed upon a force source 312 such as the bucket of a skid loader. A screw handle 314 can then be used to tighten and clamp force source connector 302 to force source 312. Body 304 is coupled to force source connector 302 with fasteners 316 thus holding body 304 securely to force source connector 302. Body 304 has guide rails 308 to allow an operator of force source 312 to align a tree, brush, or post between pinchers 354.

At end 318, scissor gear 306 is coupled to body 304 via fastener 320. Coupled at the end of arms 322 and 324 are pinchers 354 and tines 356. A detent 382 is shown which provides a catch to hold pinchers 354 open. In operation, after brush remover 300 is mounted to force source 312, the operator of force source 312 could pull on cable 310 to lock open pinchers 354 via detent 382. Cable 310 would pull arm 322 and arm 324 via clip 326. Pinchers 354 would open and spring 332 coupled to fasteners 360 and 362 respectively would expand thus creating a tension force. Springs 330 coupled/attached to detent 382 which props, or locks detent 382 onto a ½ inch shaft and locks pinchers 354 in an open position. Detent 382 rotates freely about fastener 380.

In operation, the operator would align guide rails 308 up with a tree, bush, or post which needed removal from the ground. The operator would try to place the tree, bush, or post between both guide rails 308. The operator would then slowly move force source 312 toward the tree, bush, or post until the tree, bush, or post made contact with detent 382. Detent 382 will be pushed sideways releasing detent 382 from ¼ inch shaft 380 releasing spring 332 and thus closing pinchers 354 against the tree, bush, or post. The operator would then place force source 312 in a reverse direction gear and move force source 312 slowly in a reverse direction. Once the tree, bush, or post was removed the operator would then once again pull on cable 310 opening pinchers 354 allowing the tree bush, or post to fall to the ground. The tree, bush, or post could then be disposed of in an environmentally friendly way.

Thus, embodiments of the BRUSH REMOVER are disclosed. One skilled in the art will appreciate the present teachings can be practiced with embodiments other than those disclosed. The disclosed embodiments are presented for purposes of illustration and not limitation, and the present teachings are limited only by the claims follow.

1-33. (canceled)

1. An attachment for a work vehicle to be used in removing trees, roots and all, from the earth, comprising:
(a) a pair of arms having first and second ends pivotally joined to one another by a fastener pin at a location intermediate said first and second ends and each arm having a tubular sleeve at its first end and an aperture formed through a thickness dimension proximate its second end;
(b) a pair of linkages, each having an aperture formed through a thickness dimension thereof proximate first and second ends;
(c) means for pivotally coupling the first end of the pair of linkages individually to the second end of the pair of arms;
(d) an eyelet member for pivotally coupling the second ends of the pair of linkages to one another; and
(e) a pair of pinchers individually rotatably mounted in the tubular sleeves in opposing relation to one another, the pinchers having a plurality of pointed tines extending outward from a face surface, the pair of pinchers adapted to squeeze the trunk of a tree or shrub therebetween with increasing force when an increasing pulling force is applied to the eyelet.

2. The attachment of claim 49 wherein the eyelet is adapted to be coupled to the work vehicle by a chain.

3. The attachment of claim 49 and further including a tension spring operatively coupled between the means for coupling the first ends of the pair of linkages to the second ends of the pair of arms for normally urging the pinchers together.

4. The attachment of claim 49 wherein the pair of pinchers each comprise a stub axle rotatably mounted in said tubular sleeves and a circular plate joined to the stub axle, the circular plate having said face surface with tines extending outward therefrom.

5. The attachment of claim 49 wherein each of the arms includes a linear portion extending from the second end, beyond a location of the fastener pin for a distance generally equal to the distance between the second end of the arm and the fastener pin, and a portion angularly offset from the linear portion and terminating in said sleeve.

6. The attachment as in claim 52 wherein the tines are concentrically affixed to the face surface of the circular plate and equally circumferentially spaced from one another.
